(19) United States
(12) Patent Application Publication
(10) Pub. No.: US 2014/0308592 A1
(43) Pub. Date: Oct. 16, 2014

(54) METHOD OF MANUFACTURING DISPERSION LIQUID FOR ELECTRODE CATALYST, DISPERSION LIQUID FOR ELECTRODE CATALYST, METHOD OF MANUFACTURING ELECTRODE CATALYST, ELECTRODE CATALYST, ELECTRODE STRUCTURE, MEMBRANE ELECTRODE ASSEMBLY, FUEL CELL AND AIR CELL

(71) Applicants: Hajime Maki, Tsukuba-shi (JP); Yutaka Ito, Tsukuba-shi (JP); Yoshinari Sawabe, Tsukubashi (JP); Kenichiro Ota, Tokyo (JP)

(72) Inventors: Hajime Maki, Tsukuba-shi (JP); Yutaka Ito, Tsukuba-shi (JP); Yoshinari Sawabe, Tsukubashi (JP); Kenichiro Ota, Tokyo (JP)

(73) Assignee: SUMITOMO CHEMICAL COMPANY, LIMITED, Tokyo (JP)

(21) Appl. No.: 14/342,636

(22) PCT Filed: Sep. 5, 2012
(86) PCT No.: PCT/JP2012/072618

§ 371 Date: Jun. 18, 2014

(30) Foreign Application Priority Data
Sep. 6, 2011 (JP) 2011-193846
Jun. 25, 2012 (JP) 2012-142054

(51) Int. Cl. H01M 4/92; H01M 4/88

(52) U.S. Cl. CPC H01M 4/926; H01M 4/8853; H01M 4/8878
USPC 429/405; 502/5; 502/300; 502/101; 429/523; 429/524; 429/482

(57) ABSTRACT

A method of manufacturing a dispersion liquid for an electrode catalyst, the method comprising a step of supporting a precious metal on the surface of a carrier by an electrodeposition process using a raw material mixed solution in which a particulate carrier is dispersed in a solvent and a compound including the precious metal element is dissolved in the solvent, wherein the carrier has oxygen reduction capability and is free of precious metal elements.

### TECHNICAL FIELD

The present invention relates to a method of manufacturing a dispersion liquid for an electrode catalyst, a dispersion liquid for an electrode catalyst, a method of manufacturing an electrode catalyst, an electrode catalyst, an electrode structure, a membrane electrode assembly, a fuel cell and an air cell.

Priority is claimed on Japanese Patent Application No. 2011-193846, filed Sep. 6, 2011, and Japanese Patent Application No. 2012-142054, filed Jun. 25, 2012, the contents of which are incorporated herein by reference.

### BACKGROUND ART

An electrode catalyst is a solid catalyst that is supported on an electrode, and particularly on the surface region of the electrode, and such electrode catalysts are used, for example, for the electrolysis of water, the electrolysis of organic substances, and also in electrochemical systems such as fuel cells, primary cells and secondary cells. Among electrode catalysts used in acidic electrolytes or alkaline electrolytes, precious metals, and particularly platinum, are widely used due to their excellent catalytic activity.

Examples of conventional catalysts that use platinum include catalysts in which the platinum is supported on carbon or the like, and in order to enhance the performance of such materials as electrode catalysts, it has been necessary to increase the amount of supported platinum. Electrode catalysts comprising supported platinum are typically manufactured by a method in which pure water, a catalyst carrier and chloroplatinic acid are mixed, and following thorough dispersion of the chloroplatinic acid in the mixed solution, a reducing agent such as hydrazine or sodium thiosulfate is used to reduce and support the platinum on the catalyst carrier, or a method in which the mixed solution is dried, and then heat-treated in an atmosphere containing hydrogen to reduce and support the platinum on the catalyst carrier. However, problems exist with electrode catalysts manufactured using these methods, including a degradation in performance when a potential cycle including a high potential is performed (see Non-Patent Document 1).

### DOCUMENTS OF RELATED ART

### Non-Patent Document

Non-Patent Document 1: Ping Yu et al., Journal of Power Sources, 2005, vol. 144, pages 11 to 20

### SUMMARY OF THE INVENTION

### Problems to be Solved by the Invention

The present invention has been developed in light of the above circumstances, and has objects of providing a method of manufacturing a dispersion liquid for an electrode catalyst, a dispersion liquid for an electrode catalyst, a method of manufacturing an electrode catalyst, an electrode catalyst which is resistant to performance degradation in an acidic electrolyte or an alkaline electrolyte even if a potential cycle including a high potential is performed, an electrode structure comprising the electrode catalyst, a membrane electrode assembly comprising the electrode structure, and a fuel cell and an air cell comprising the membrane electrode assembly.

### Means to Solve the Problems

In order to achieve the above objects, one aspect of the present invention provides a method of manufacturing a dispersion liquid for an electrode catalyst, the method comprising a step of supporting a precious metal on the surface of a carrier by an electrodeposition process using a raw material mixed solution in which a particulate carrier is dispersed in a solvent and a compound including the precious metal element is dissolved in the solvent, wherein the carrier has oxygen reduction capability and is free of precious metal elements.

In the method of manufacturing a dispersion liquid for an electrode catalyst according to one aspect of the present invention, the electrodeposition process is preferably performed by photodeposition.

In the method of manufacturing a dispersion liquid for an electrode catalyst according to one aspect of the present invention, the precious metal element is preferably a precious metal element selected from the group consisting of Pt, Pd, Au, Ir and Ru.

One aspect of the present invention provides a dispersion liquid for an electrode catalyst obtained by the method of manufacturing a dispersion liquid for an electrode catalyst described above.

One aspect of the present invention provides a method of manufacturing an electrode catalyst, the method comprising removing the solvent from the dispersion liquid for an electrode catalyst described above to obtain an electrode catalyst.

One aspect of the present invention provides an electrode catalyst obtained by the method of manufacturing an electrode catalyst described above.

One aspect of the present invention provides an electrode catalyst comprising:

a particulate carrier having oxygen reduction capability and being free of precious metal elements, and

precious metal particles which are supported on a surface of the carrier, wherein

the carrier has a nitrogen atom at least on the surface thereof, and the nitrogen atom is chemically bonded to a precious metal element which forms the precious metal particles.

In the electrode catalyst according to one aspect of the present invention, the precious metal element which forms the precious metal particles is preferably Pt.

One aspect of the present invention provides an electrode structure comprising the electrode catalyst described above.

One aspect of the present invention provides a membrane electrode assembly comprising the electrode structure described above.

One aspect of the present invention provides a fuel cell comprising the membrane electrode assembly described above.

One aspect of the present invention provides an air cell comprising the membrane electrode assembly described above.

In other words, the present invention relates to the following.

[1] A method of manufacturing a dispersion liquid for an electrode catalyst, the method comprising a step of supporting a precious metal on a surface of a carrier by an electrodeposition process using a raw material mixed solution in which a particulate carrier is dispersed in a solvent and a compound including the precious metal element is dissolved in the solvent, wherein

the carrier is a compound having oxygen reduction capability and being free of precious metal elements.

[2] The method of manufacturing a dispersion liquid for an electrode catalyst according to [1], wherein the electrodeposition process is performed by photodeposition.

[3] The method of manufacturing a dispersion liquid for an electrode catalyst according to [1] or [2], wherein the precious metal element is at least one precious metal element selected from the group consisting of Pt, Pd, Au, Ir and Ru.

[4] A dispersion liquid for an electrode catalyst obtained by the method of manufacturing a dispersion liquid for an electrode catalyst according to any one of [1] to [3].

[5] A method of manufacturing an electrode catalyst, the method comprising removing the solvent from the dispersion liquid for an electrode catalyst according to [4] to obtain an electrode catalyst.

An electrode catalyst obtained by the method of manufacturing an electrode catalyst according to [5].

[7] An electrode catalyst comprising: a particulate carrier having oxygen reduction capability and being free of precious metal elements, and precious metal particles which are supported on a surface of the carrier, wherein the carrier has a nitrogen atom at least on a surface thereof, and the nitrogen atom is chemically bonded to a precious metal element which forms the precious metal particles.

[8] The electrode catalyst according to [7], wherein the precious metal element which forms the precious metal particles is Pt.

[9] An electrode structure comprising the electrode catalyst according to any one of [6] to [8].

[10] A membrane electrode assembly comprising the electrode structure according to [9].

[11] A fuel cell comprising the membrane electrode assembly according to [10].

[12] An air cell comprising the membrane electrode assembly according to [10].

### EFFECTS OF THE INVENTION

The present invention is able to provide a method of manufacturing a dispersion liquid for an electrode catalyst, a dispersion liquid for an electrode catalyst, a method of manufacturing an electrode catalyst, an electrode catalyst which is resistant to performance degradation in an acidic electrolyte or an alkaline electrolyte even if a potential cycle including a high potential is performed, an electrode structure having the electrode catalyst, a membrane electrode assembly having the electrode structure, and a fuel cell and an air cell having the membrane electrode assembly.

### BRIEF DESCRIPTION OF THE DRAWINGS

FIG. 1 is a longitudinal sectional view of a cell of a fuel cell according to a preferred embodiment of the present invention.

FIG. 2 is a longitudinal sectional view of a membrane electrode assembly according to a preferred embodiment of the present invention.

FIG. 3 is a schematic diagram illustrating an outline of a reaction apparatus (continuous flow reaction apparatus) for performing a continuous hydrothermal reaction according to a preferred embodiment of the present invention.

FIG. 4 is a TEM photograph of a particulate carrier obtained in an example 1.

FIG. 5 is an EF-TEM photograph (white indicates carbon) of the particulate carrier obtained in example 1.

FIG. 6 is a TEM photograph of an electrode catalyst formed by supporting a precious metal on the surface of the particulate carrier obtained in example 1.

### EMBODIMENTS FOR CARRYING OUT THE INVENTION

Embodiments of the present invention are described below in detail.

### (Dispersion Liquid for Electrode Catalyst and Method of Manufacturing Same)

The method of manufacturing a dispersion liquid for an electrode catalyst according to one embodiment of the present invention comprises a step of supporting a precious metal on a surface of a carrier by an electrodeposition process using a raw material mixed solution in which a particulate carrier (B) is dispersed in a solvent (A) and a compound (C) including the precious metal element is dissolved in the solvent (A), wherein the carrier has oxygen reduction capability and is free of precious metal elements.

Further, another aspect of the method of manufacturing a dispersion liquid for an electrode catalyst according to the present invention comprises:

a step of preparing a raw material mixed solution by dispersing a particulate carrier (B) and dissolving a compound (C) including a precious metal element in the solvent (A), and

a step of supporting the precious metal on a surface of the carrier in the raw material mixed solution by an electrodeposition process, wherein

the carrier has oxygen reduction capability and is free of precious metal elements.

According to the method of manufacturing a dispersion liquid for an electrode catalyst that represents an embodiment of the present invention, a dispersion liquid for an electrode catalyst can be obtained in which a precious metal has been supported on a particulate carrier (B) by an electrodeposition process.

Compared with conventional electrode catalysts, the electrode catalyst in the dispersion liquid for an electrode catalyst according to an embodiment of the present invention is resistant to performance degradation, even if a potential cycle including a high potential, such as a potential of 0.8 V or greater in an acidic electrolyte or a potential of −0.1 V or greater in an alkaline electrolyte, is performed in a saturated oxygen atmosphere.

In one embodiment of the present invention, the expression “has oxygen reduction capability” means that the carrier has an oxygen reduction current density of −0.001 mA/cm² or less at 0.8 V when evaluated using the evaluation technique “(4) Oxygen reduction capability evaluation” disclosed in the examples described below. The oxygen reduction current density is used as an indicator, wherein a relatively smaller value indicates a higher oxygen reduction capability.

In the following description, the “particulate carrier (B)” is sometimes referred to as the “carrier (B)”.

Further, the “compound (C) including the precious metal element” is sometimes referred to as the “compound (C)”.

Furthermore, in the following description, each of the potential values disclosed in the specification, including the potential when evaluation is performed in the “(4) Oxygen reduction capability evaluation” disclosed in the examples described below, represents a value relative to the reversible hydrogen electrode potential.

Specific examples of the compound “having oxygen reduction capability and being free of precious metal elements” which constitutes the particulate carrier include:

(a) compounds obtained by partial oxidation treatment of an oxynitride or a carbonitride of a metal element of group 4 or a metal element of group 5 of the long form of the periodic table;

(b) compounds obtained by firing a Fe phthalocyanine or a Co phthalocyanine or the like, and a carbon source containing nitrogen, boron or oxygen, in an inert atmosphere or an ammonia atmosphere; and

(c) compounds obtained by subjecting a hydroxide containing a metal element of group 4 or a metal element of group 5 of the long form of the periodic table, a hydroxide containing at least one metal element selected from among the lanthanoids, a carbon precursor, a nitrogen-containing compound and a conductive material to a hydrothermal reaction treatment, a subcritical treatment or a supercritical treatment, and then performing firing in an inert atmosphere such as nitrogen.

In the above description of compounds (a), examples of the “oxynitride of a metal element of group 4 or a metal element of group 5 of the long form of the periodic table” include TiON, ZrON, NbON and TaON.

Further, examples of the “carbonitride of a metal element of group 4 or a metal element of group 5 of the long form of the periodic table” include TiCN, ZrCN, NbCN and TaCN.

In the above description of compounds (a), “partial oxidation treatment” means increasing the oxygen content of the treatment target material by oxidizing the treatment target material.

In the above description of compounds (b), examples of the “carbon source containing oxygen” include saccharides such as glucose, fructose, sucrose, cellulose and hydropropylcellulose; alcohols such as polyvinyl alcohol; glycols such as polyethylene glycol and polypropylene glycol; polyesters such as polyethylene terephthalate; various proteins such as collagen, keratin, ferritin, hormones, hemoglobin and albumin; biological materials containing various amino acids such as glycine, alanine and methionine; organic acids such as ascorbic acid, citric acid and stearic acid; and isoxazole, morpholine, acetamide and hydroxylamine. In the above description of compounds (b), “firing” means heating the treatment target material in an oxygen-free atmosphere at conditions of 600 to 1,400° C.

The supercritical point of water is 374° C., 22 MPa. In the above description of compounds (c), a “supercritical treatment” means a treatment in which the treatment target material is placed in supercritical state water and subjected to a hydrothermal reaction.

“Supercritical state water” means water under conditions including a temperature of at least 374° C. and a pressure of at least 22 MPa.

Further, in the above description of compounds (c), a “subcritical treatment” means a treatment in which the treatment target material is placed in subcritical state water and subjected to a hydrothermal reaction.

“Subcritical state water” means water under conditions including a temperature of at least 200° C. and a pressure of at least atmospheric pressure, in which at least one of the temperature and the pressure is less than the supercritical point. The subcritical state water preferably has a pressure of at least 20 MPa and a temperature of at least 200° C. but less than 373° C., or a temperature of at least 200° C. and a pressure of at least 20 MPa but less than 22 MPa.

Further, in the above description of compounds (c), a “hydrothermal reaction treatment” means, for example, reacting the treatment target material at a temperature of 100 to 200° C. and a pressure of 1 to 20 MPa.

In the above description of compounds (c), “firing” means, for example, heating the treatment target material in an inert atmosphere such as nitrogen at a temperature of 600 to 1,600° C., and preferably 700 to 1,400° C. This causes carbonization of part or all of the treatment target material.

In the above description of compounds (c), examples of the “hydroxide containing a metal element of group 4 or a metal element of group 5” include zirconium hydroxide, hafnium hydroxide, metatitanic acid, niobic acid and tantalic acid.

Further, in the above description of compounds (c), examples of the “hydroxide containing at least one metal element selected from among the lanthanoids” include cerium hydroxide and lanthanum hydroxide.

Furthermore, in the above description of compounds (c), the “carbon precursor” describes a compound that produces carbon upon firing. Specific examples include saccharides such as glucose, fructose, sucrose, cellulose and hydropropylcellulose; alcohols such as polyvinyl alcohol; glycols such as polyethylene glycol and polypropylene glycol; polyesters such as polyethylene terephthalate; nitriles such as acrylonitrile and polyacrylonitrile; various proteins such as collagen, keratin, ferritin, hormones, hemoglobin and albumin; biological materials containing various amino acids such as glycine, alanine and methionine; and organic acids such as ascorbic acid, citric acid and stearic acid.

Moreover, in the above description of compounds (c), examples of the “ nitrogen-containing compound” include heterocyclic compounds such as pyrrole, imidazole, pyrazole, isoxazole, pyridine, pyridazine, pyrimidine, pyrazine, piperidine, piperazine, morpholine, and derivatives thereof; amide compounds such as acetamide and cyanamide; hydroxylamines such as hydroxylamine and hydroxylamine sulfate; and ammonia and urea. Among these, ammonia or urea is preferable as the nitrogen-containing compound.

Further, in the above description of compounds (c), examples of the “conductive material” include carbon fiber, carbon nanotubes, carbon nanofiber, conductive oxides, conductive oxide fiber, and conductive resins.

Furthermore, the expression that the particulate carrier (B) used as a raw material is “free of precious metal elements” means that the carrier contains absolutely no precious metal elements, specifically gold (Au), silver (Ag), ruthenium (Ru), rhodium

(Rh), palladium (Pd), osmium (Os), iridium (Ir) and platinum (Pt). In other words, in the present invention, the above precious metal elements cannot be detected in the particulate carrier used as a raw material. This elemental analysis can be performed by inductively coupled plasma (ICP) emission analysis.

In one embodiment of the present invention, in order to ensure a high degree of dispersion of the supported precious metal, the primary particle size of the carrier (B) used as a raw material and the primary particle size of the carrier (B) in the dispersion liquid are preferably at least 1 nm but not more than 100 nm, and more preferably at least 2 nm but not more than 50 nm.

In one embodiment of the present invention, in order to ensure a high degree of dispersion of the supported precious metal, the BET specific surface area of the carrier (B) used as a raw material and the BET specific surface area of the carrier (B) in the dispersion liquid are preferably at least 50 m²/g but not more than 1,000 m²/g, and more preferably at least 70 m²/g but not more than 500 m²/g.

When either a compound obtained by partial oxidation treatment of a carbonitride is used from among the above compounds (a), or an above-mentioned compound (c) is used, the material for forming the carrier (B) used in an embodiment of the present invention adopts a structure in which a metal element of group 4 or group 5 of the long form of the periodic table is coated with a layer of a carbon compound. In this case, in order to enhance the oxygen reduction capability of the carrier (B), the carbon compound contained in the layer which coats the metal element preferably comprises nitrogen.

When the carbon compound contained in the carrier (B) used in an embodiment of the present invention comprises nitrogen, the nitrogen content is preferably at least 0.1% by mass but not more than 20% by mass, and more preferably at least 0.5% by mass but not more than 15% by mass.

The precious metal element contained in the compound (C) used in an embodiment of the present invention is preferably Pt, Pd, Au, Ir or Ru. Further, examples of the compound (C) include the sulfides, chlorides, nitrates and oxo ions of the above precious metals.

The amount of the compound (C) mixed with the dispersion liquid containing the carrier (B) dispersed in the solvent (A), calculated in terms of an equivalent amount of the precious metal element, is typically at least 0.1 parts by mass but not more than 60 parts by mass, preferably at least 1 part by mass but not more than 30 parts by mass, and more preferably at least 2 parts by mass but not more than 15 parts by mass, per 100 parts by mass of the carrier (B). If the amount of the precious metal element is large, then the manufacturing costs increase, whereas if the amount of added precious metal element is small, then the effects of the obtained dispersion liquid for an electrode catalyst and the electrode catalyst itself tend to diminish.

Examples of the compound (C) used in an embodiment of the present invention include the following compounds.

Examples of the compound (C) including Pt as the precious metal element include platinum chlorides (PtCl₂, PtCl₄), platinum bromides (PtBr₂, PtBr₄), platinum iodides (PtI₂, PtI₄), potassium chloroplatinate (K₂(PtCl₄)), hexachloroplatinic acid (H₂PtCl₆), platinum sulfite (H₃Pt(SO₃)₂OH), tetraammineplatinum chloride (Pt(NH₃)₄Cl₂), tetraammineplatinum hydrogen carbonate (C₂H₁₄N₄O₆Pt), tetraammineplatinum hydrogen phosphate (Pt(NH₃)₄HPO₄), tetraammineplatinum hydroxide (Pt(NH₃)₄(OH)₂), tetraammineplatinum nitrate (Pt(NO₃)₂(NH₃)₄), tetraammineplatinum tetrachloroplatinate ((Pt(NH₃)₄)(PtCl₄)), and dinitrodiammineplatinum (Pt(NO₂)₂(NH₃)₂).

Examples of the compound (C) including Pd as the precious metal element include palladium acetate ((CH₃COO)₂Pd), palladium chloride (PdCl₂), palladium bromide (PdBr₂), palladium iodide (PdI₂), palladium hydroxide (Pd(OH)₂), palladium nitrate (Pd(NO₃)₂), palladium sulfate (PdSO₄), potassium tetrachloropalladate (K₂(PdCl₄)), potassium tetrabromopalladate (K₂(PdBr₄)), tetraamminepalladium chloride (Pd(NH₃)₄Cl₂), tetraamminepalladium bromide (Pd(NH₃)₄Br₂), tetraamminepalladium nitrate (Pd(NH₃)₄(NO₃)₂), tetraamminepalladium tetrachloropalladate ((Pd(NH₃)₄)(PdCl₄)), and ammonium tetrachloropalladate ((NH₄)₂PdCl₄).

Examples of the compound (C) including Au as the precious metal element include gold chloride (AuCl), gold bromide (AuBr), gold iodide (Aul), gold hydroxide (Au(OH)₂), tetrachloroauric acid (HAuCl₄), potassium tetrachloroaurate (KAuCl₄), and potassium tetrabromoaurate (KAuBr₄).

Examples of the compound (C) including Ir as the precious metal element include iridium chloride (IrCl₃), iridium bromide (IrBr₄), and iridium iodide (IrI₄).

Examples of the compound (C) including Ru as the precious metal element include ruthenium bromide (RuBr₃), ruthenium chloride (RuCl₃), ruthenium iodide (RuI₃), ruthenium nitrosyl chloride hydrate (Ru(NO)Cl₃.H₂O), ruthenium nitrosyl nitrate (Ru(NO)(NO₃)₃), and ruthenium porphyrin complex (C₅₇H₅₂N₄ORu).

The compound (C) described above may use only a single type of compound, or may use 2 or more types of compounds.

Examples of the solvent (A) used in one embodiment of the present invention include ion-exchanged water; alcohols such as methanol, ethanol, butanol, isopropyl alcohol and normal propanol; glycols such as polypropylene glycol; ketones such as acetone; and carboxylic acids such as oxalic acid. The above-mentioned solvents other than ion-exchanged water used as the solvent (A) also function as sacrificial agents during photodeposition. Further, organic substances that dissociate from the compound (C) also function as sacrificial agents.

By dispersing the carrier (B) and dissolving the compound (C) in this type of solvent (A), a raw material mixed solution can be obtained.

Examples of the device used when dispersing the carrier (B) in the solvent (A) include an ultrasonic disperser, a beads mill, a sand grinder, a homogenizer, a wet jet mill, a ball mill and a stirrer.

Further, when dispersing the carrier (B) in the solvent (A), a dispersant may be used in combination with the solvent (A) and the carrier (B), provided that the dispersant does not impair the functions of the electrode catalyst obtained using the method of manufacturing an electrode catalyst according to an embodiment of the present invention.

The amount of the dispersant is typically at least 0.01 parts by mass but not more than 10 parts by mass, preferably at least 0.1 parts by mass but not more than 7 parts by mass, and more preferably at least 0.5 parts by mass but not more than 5 parts by mass, per 100 parts by mass of the carrier (B) used as a raw material.

Examples of the dispersant include inorganic acids such as nitric acid, hydrochloric acid and sulfuric acid; organic acids such as oxalic acid, citric acid, acetic acid, malic acid and lactic acid; water-soluble zirconium salts such as zirconium oxychloride; surfactants such as ammonium polycarboxylate and sodium polycarboxylate; catechins such as epicatechin, epigallocatechin and epigallocatechin gallate; fluorine-based ion exchange resins such as Nafion (a registered trademark of E. I. du Pont de Nemours and Company); and hydrocarbon-based ion exchange resins such as sulfonated phenol-formaldehyde resins.

In one embodiment of the present invention, the raw material mixed solution is obtained by dissolving the compound (C) in a dispersion liquid prepared by dispersing the carrier (B) in the solvent (A).

The solid fraction concentration of the raw material mixed solution is typically at least 0.1% by mass but not more than 50% by mass, and preferably at least 1% by mass but not more than 30% by mass. If the solid fraction concentration within the raw material mixed solution is low, then the efficiency of the electrodeposition may sometimes deteriorate. On the other hand, if the solid fraction concentration within the raw material mixed solution is too high, then performing the electrodeposition may become difficult due to an increase in the viscosity of the raw material mixed solution.

The method of obtaining the raw material mixed solution was described as a method in which the carrier (B) is first dispersed in the solvent (A), and the compound (C) is then dissolved therein, but the order of the dispersion of the carrier (B) and the dissolution of the compound (C) in the solvent (A) may be reversed. In other words, the raw material mixed solution may also be obtained by first preparing a solution by dissolving the compound (C) in the solvent (A), and then dispersing the carrier (B) in the obtained solution. When dispersing the carrier (B), the techniques and dispersants described above can be used.

By performing an electrodeposition process using the obtained raw material mixed solution, the precious metal is supported on the surface of the carrier (B).

Examples of the electrodeposition process used include electrolytic reduction and photodeposition, and photodeposition is preferable.

In the present invention, an “electrodeposition process” specifically describes a process in which electrons in the carrier are excited electrically, and these excited electrons are used to reduce the precious metal element ions, thereby supporting the precious metal element on the surface of the carrier.

Moreover, “photodeposition” specifically describes a process in which electrons in the carrier are excited by irradiating light onto the carrier, and these excited electrons are used to reduce the precious metal element ions, thereby supporting the precious metal element on the surface of the carrier.

There are no particular limitations on the light source used during the photodeposition, provided it is capable of irradiating a light that has an energy level capable of releasing photoelectrons from the carrier (B), thereby reducing the precious metal element ions and supporting the precious metal element on the surface of the carrier (B). Specific examples of the light source include a germicidal lamp, a mercury lamp, a light emitting diode, a fluorescent lamp, a halogen lamp, a xenon lamp and sunlight.

The wavelength of the light irradiated from the light source is preferably from 180 to 500 nm. The light irradiation may be performed while stirring the raw material mixed solution. The raw material mixed solution may be passed through a transparent tube made of a glass or plastic while irradiation is performed from inside and outside the tube, and this process may be repeated as required.

The time period for which irradiation is performed is preferably at least 10 minutes but not more than 24 hours, and more preferably at least 30 minutes but not more than 6 hours.

The precious metal reduced by the electrodeposition process is deposited in particulate form on the surface of the carrier (B). The primary particle size of the particles of the precious metal (precious metal particles) is preferably at least 0.1 nm but not more than 50 nm, and more preferably at least 1 nm but not more than 10 nm.

Further, the supported precious metal particles are preferably dispersed uniformly across the surface of the carrier (B).

The precious metal particles have chemical bonds to nitrogen atoms that exist on the surface of the carrier (B). By forming chemical bonds between the precious metal element (precious metal particles) supported on the surface of the carrier (B) and nitrogen atoms of the carrier (B), the electron density of the precious metal element increases. Further, formation of an oxide film on the surface of the precious metal particles is inhibited, improving the durability and activity.

The formation of chemical bonds between the precious metal element (namely, the precious metal particles) supported on the surface of the carrier (B) in the raw material mixed solution and nitrogen atoms of the carrier (B) in the raw material mixed solution can be confirmed by XPS analysis. XPS analysis is performed using an X-ray photoelectron spectrometer (Quantera SXM manufactured by Ulvac-Phi Inc.), by performing measurements using Al Kα rays (1486.6 eV) as the X-rays to determine the X-ray photoelectron spectrum (XPS spectrum). The XPS spectrum is obtained by graphing the measurement results with the photoelectron energy based on the irradiated X-rays shown along the horizontal axis (X axis) and the number of photoelectrons shown along the vertical axis (Y axis).

In this type of XPS spectrum, when the count for the peak corresponding with a bond between the precious metal element and a nitrogen atom is 300 or greater, chemical bonds can be deemed to have formed between the precious metal element and nitrogen atoms.

The “peak corresponding with a bond between the precious metal element and a nitrogen atom” is observed in the vicinity of the peak corresponding with a carbon atom-nitrogen atom bond (near 400 eV). For example, a peak corresponding with a Pt—N bond is observed at 395 eV.

The dispersion liquid for an electrode catalyst according to one embodiment of the present invention may include a conductive material, provided that the functions of the electrode catalyst obtained using the method of manufacturing an electrode catalyst according to an embodiment of the present invention are not impaired.

The amount of the conductive material is typically at least 0.1 parts by mass but not more than 100 parts by mass, preferably at least 1 part by mass but not more than 70 parts by mass ,and more preferably at least 5 parts by mass but not more than 50 parts by mass, per 100 parts by mass of the carrier (B) used as a raw material.

Examples of the conductive material include carbon fiber, carbon nanotubes, carbon nanofiber, conductive oxides, conductive oxide fiber, and conductive resins.

In the manner described above, a dispersion liquid for an electrode catalyst can be obtained in which a precious metal is supported on the carrier (B) using an electrodeposition process.

### (Electrode Catalyst and Method of Manufacturing Same)

An electrode catalyst according to one embodiment of the present invention can be obtained by removing the solvent from the dispersion liquid for an electrode catalyst manufactured in the manner described above.

The electrode catalyst according to an embodiment of the present invention comprises the particulate carrier (B) having oxygen reduction capability and being free of precious metal elements; and precious metal particles which are supported on the surface of the carrier (B). The carrier (B) has nitrogen atoms at least on the surface thereof, and these nitrogen atoms are chemically bonded to the precious metal element which forms the precious metal particles. The precious metal element which forms the precious metal particles is preferably Pt.

By manufacturing the electrode catalyst of one embodiment of the present invention using the electrodeposition process described above, or by ensuring that the electrode catalyst has the structure described above, the electrode catalyst is more resistant to performance degradation than conventional electrode catalysts. For example, the electrode catalyst according to an embodiment of the present invention is resistant to performance degradation even if a potential cycle including a high potential, such as a potential of 0.8 V or greater in an acidic electrolyte or a potential of −0.1 V or greater in an alkaline electrolyte, is performed in a saturated oxygen atmosphere.

### (Electrode Structure)

An electrode structure in which the electrode catalyst is layered on an electrode such as a carbon cloth or carbon paper can be obtained by applying the dispersion liquid for an electrode catalyst according to one embodiment of the present invention to the electrode using a die coater or a sprayer, and then drying the dispersion liquid to remove the solvent (A). The amount of the solvent relative to the electrode catalyst in the electrode structure is approximately 0.01 to 1.0% by mass.

The electrode structure according to one embodiment of the present invention can also be obtained by applying the above-mentioned raw material mixed solution to an electrode, performing electrodeposition (photodeposition) of the raw material mixed solution on the electrode, and subsequently performing drying to remove the solvent (A).

The electrode structure according to an embodiment of the present invention can be used as an electrode for the electrolysis of water in an acidic electrolyte or an alkaline electrolyte, the electrolysis of organic substances, and also as the electrode of a fuel cell or the like.

### (Membrane Electrode Assembly)

A membrane electrode assembly (MEA) in one embodiment of the present invention can be obtained by crimping the electrode structure according to the above-mentioned embodiment of the present invention to an ion exchange membrane. An “ion exchange membrane” is a membrane produced by molding an ion exchange resin into membrane form, and examples include a proton conducting membrane and an anion exchange membrane. The obtained membrane electrode assembly can be used in a solid polymer fuel cell, a phosphoric acid fuel cell, a direct methanol fuel cell, a direct ethanol fuel cell, an alkali fuel cell, or an air cell or the like.

### (Fuel Cell)

Next is a description of a preferred embodiment of a fuel cell comprising an above-mentioned membrane electrode assembly of the present invention, based on the appended drawings.

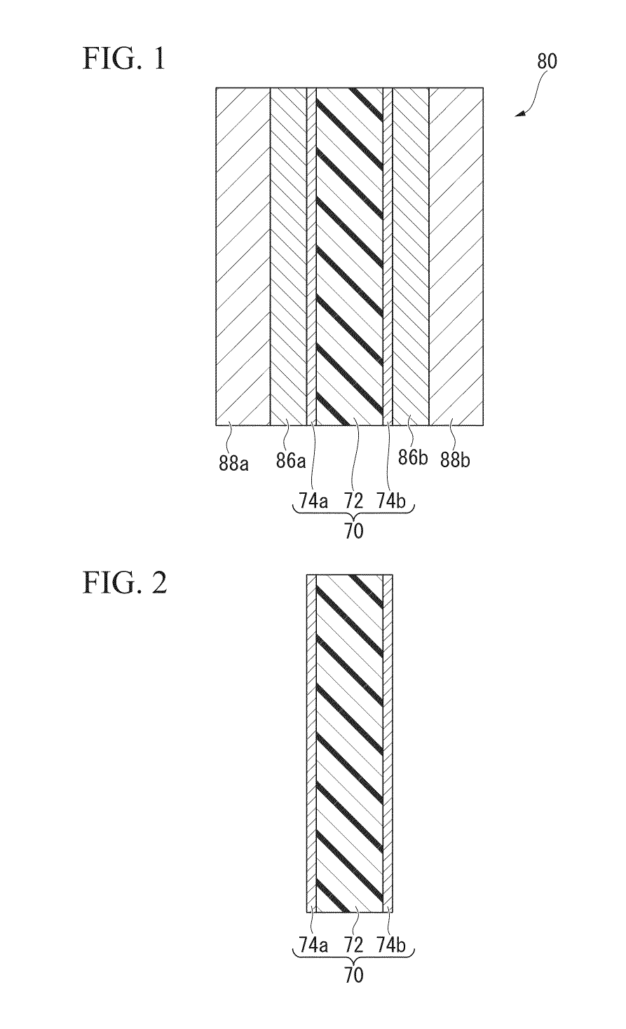

FIG. 1 is a longitudinal sectional view of a cell of a fuel cell according to a preferred embodiment of the present invention. FIG. 2 is a longitudinal sectional view of a membrane electrode assembly according to a preferred embodiment of the present invention. In FIG. 1, a fuel cell 80 comprises a membrane electrode assembly 70 composed of an electrolyte membrane 72 (proton conducting membrane) sandwiched between a pair of catalyst layers 74a and 74b (namely, the membrane electrode assembly according to an embodiment of the present invention illustrated in FIG. 2). The fuel cell 80 comprises gas diffusion layers 86a and 86b and then separators 88a and 88b sandwiching the two sides of the membrane electrode assembly 70 (wherein channels (not shown in the figures) that function as flow paths for the fuel gas and the like are preferably formed in the separators 88a and 88b on the sides facing the catalyst layers 74a and 74b). The structure composed of the electrolyte membrane 72, the catalyst layers 74a and 74b, and the gas diffusion layers 86a and 86b is typically called a membrane electrode gas diffusion layer assembly (MEGA).

The catalyst layers 74a and 74b are layers that function as the electrode layers in the fuel cell, and one of these layers functions as the anode electrode layer, and the other functions as the cathode electrode layer. These catalyst layers 74a and 74b comprise the electrode catalyst according to an embodiment of the present invention described above, and an electrolyte having proton conductivity typified by Nafion (a registered trademark).

Examples of electrolytes that can be used as the electrolyte membrane 72 (proton conducting membrane) include Nafion NRE211, Nafion NRE212, Nafion 112, Nafion 1135, Nafion 115 and Nafion 117 (all manufactured by E. I. du Pont de Nemours and Company), as well as Flemion (manufactured by Asahi Glass Co., Ltd.) and Aciplex (manufactured by Asahi Kasei Chemicals Corporation) (all of the above are brand names and registered trademarks).

The gas diffusion layers 86a and 86b are layers which have the function of promoting diffusion of the raw material gas to the catalyst layers 74a and 74b. These gas diffusion layers 86a and 86b are preferably formed from a porous material that exhibits electron conductivity. Porous carbon nonwoven fabrics and carbon papers are preferred as this porous material, as they enable the raw material gas to be transported efficiently to the catalyst layers 74a and 74b.

The separators 88a and 88b are formed from a material that exhibits electron conductivity. Examples of this material that exhibits electron conductivity include carbon, resin mold carbon, titanium and stainless steel.

Next is a description of a preferred method of manufacturing the fuel cell 80.

First, the dispersion liquid for an electrode catalyst according to one embodiment of the present invention is applied to a carbon nonwoven fabric or a carbon paper using a spraying method or screen printing method, and by subsequently evaporating the solvent and the like, a laminate is obtained in which the catalyst layers 74a and 74b have been formed on the gas diffusion layers 86a and 86b.

Following formation of a pair of these laminates, the obtained pair of laminates are positioned with the catalyst layers 74a and 74b facing each other, and the electrolyte membrane 72 is disposed therebetween. By crimping the pair of laminates and the electrolyte membrane 72, a MEGA is obtained.

This MEGA is sandwiched between a pair of separators 88a and 88b, and by bonding these together, the fuel cell 80 is obtained. This fuel cell 80 may also be sealed using a gas seal or the like.

Formation of the catalyst layers 74a and 74b on the gas diffusion layers 86a and 86b can also be achieved, for example, by applying the dispersion liquid for the electrode catalyst to a substrate of a polyimide or a poly(tetrafluoroethylene) or the like, drying the dispersion liquid to form a catalyst layer, and then transferring the catalyst layer to the gas diffusion layer using a hot press.

Further, the fuel cell 80 is the minimum unit of a solid polymer fuel cell, and the output of such a single fuel cell 80 is limited. Accordingly, a plurality of the fuel cells 80 are preferably connected in series and used as a fuel cell stack in order to achieve the required output.

The fuel cell according to one embodiment of the present invention can be operated as a solid polymer fuel cell when the fuel is hydrogen, or can be operated as a direct methanol fuel cell when the fuel is methanol.

The electrode catalyst according to one embodiment of the present invention can be used as an electrode catalyst for a fuel cell or as a catalyst for water electrolysis, but is preferably used as an electrode catalyst for a fuel cell. A fuel cell which uses the electrode catalyst and the membrane electrode assembly according to embodiments of the present invention is useful, for example, as an electric power source for electric vehicles, a domestic electric power source, or a compact electric power source for use in mobile equipment such as cellular telephones and portable personal computers.

### (Air Cell)

The electrode structure and the membrane electrode assembly according to the above-mentioned embodiments of the present invention can also be used as an electrode for an air cell. An “air cell” is a cell that uses oxygen in the air as the positive electrode active material, and a metal as the negative electrode active material. In an air cell, in order to introduce oxygen in the air into the cell, a material having a catalytic action composed of a porous carbon material, a porous metal material, or a composite material of both these types of material is typically used as the air electrode (positive electrode), any of various metals is used as the negative electrode, and an aqueous solution of potassium hydroxide or the like is used for the electrolyte. During discharge of the air cell, oxygen (O₂) in the air is dissolved in the electrolyte as OH⁻ under the catalytic action of the air electrode (anode), and this OH⁻ reacts with the negative electrode active material to generate an electromotive force. The electrode structure and the membrane electrode assembly according to the embodiments of the present invention described above can be used as the negative electrode of an air cell. An air cell which uses the electrode structure and the membrane electrode assembly according to embodiments of the present invention is useful, for example, as an electric power source for electric vehicles, a domestic electric power source, or a compact electric power source for use in mobile equipment such as cellular telephones and portable personal computers.

### EXAMPLES

the present invention is described below in further detail based on a series of examples, but the present invention is in no way limited by these examples.

The evaluation methods used in example 1 and comparative example 1 were as follows.

(1) BET Specific Surface Area:

The BET specific surface area (m²/g) was determined by the nitrogen adsorption method using a BET specific surface area measuring device (model name: Macsorb HB1208, manufactured by Mountech Co., Ltd.).

(2) Crystal Structure:

The crystal structure was determined using a powder X-ray diffraction device (device name: X'Pert, manufactured by PANanalytical B.V.), using Cu spheres as a target, under conditions including a voltage of 45 kV, a current of 40 mA, and a measurement range of 10 to 90°.

(3) Carbon Content:

The value (ignition loss value) for the carbon content calculated from the following equation when the temperature was raised from room temperature to 800° C. using a TG/DTA (model name: Exstar 6000, manufactured by SIT) under conditions including a rate of temperature increase of 10° C/minute and under a stream of air was used as the carbon content.

Carbon content (% by mass)=(WI−WA)/WI×100

wherein WI represents the mass of the electrode catalyst before firing, and WA represents the mass after firing.

(4) Evaluation of Oxygen Reduction Capability:

Ten mL of pure water, 10 mL of isopropyl alcohol, and 0.6 g of a solution (solid fraction concentration: 5% by mass) of Nafion (a registered trademark of E. I. du Pont de Nemours and Company) were mixed to prepare a mixed solvent. A 0.5 mL sample of the mixed solvent was extracted, 0.01 g of the electrode catalyst was mixed with the solvent, and the mixture was irradiated with ultrasonic waves to form a suspension.

Thirty μL of this suspension was applied to a glassy carbon electrode (manufactured by Nikko Keisoku Co., Ltd., diameter: 6 mm, electrode surface area: 28.3 mm²), and following air drying, the electrode was treated in a vacuum dryer for 1 hour, thereby supporting the electrode catalyst on the glassy carbon electrode to obtain a modified electrode.

The thus obtained modified electrode was immersed in an aqueous solution of sulfuric acid with a concentration of 0.1 mol/L, and was evaluated using an RRDE speed controller (model name: SC-5, manufactured by Nikko Keisoku Co., Ltd.) and an electrochemical analyzer (model name: Model 701C, manufactured by BAS Inc.), under conditions including room temperature (approximately 25° C.), atmospheric pressure, and an electrode rotation rate of 600 rpm.

First, as a pretreatment for the modified electrode, the potential was changed, under a nitrogen atmosphere, while increasing the voltage at a rate of 50 mV/second within a potential range from greater than 0 V to less than 1.0 V, and the potential was then changed in reverse while reducing the voltage at a rate of 50 mV/second within a potential range from less than 1.0 V to greater than 0 V. The combination of this voltage increase and subsequent voltage decrease was deemed 1 cycle, and 10 cycles were performed.

Subsequently, in a nitrogen atmosphere or an oxygen atmosphere, the potential was changed within the potential range from less than 1.0 V to greater than 0 V at a rate of 5 mV/second, and the current was determined under a nitrogen atmosphere and an oxygen atmosphere. By subtracting the obtained current in the nitrogen atmosphere from the obtained current in the oxygen atmosphere, the oxygen reduction current in the potential range from greater than 0 V to less than 1.0 V was calculated, and by dividing the current value at 0.8 V, obtained from the oxygen reduction current values within the potential range from greater than 0 V to less than 1.0 V, by the electrode surface area (28.3 mm²), the oxygen reduction current density was determined.

The modified electrode was deemed to have oxygen reduction capability when the obtained value for the oxygen reduction current density was −0.001 mA/cm² or less.

(5) Evaluation of Oxygen Reduction Current Density of Electrode Catalyst:

Dispersion liquids for electrode catalysts obtained in accordance with the examples and comparative examples described below were each applied to a glassy carbon electrode (manufactured by Nikko Keisoku Co., Ltd., diameter: 6 mm, electrode surface area: 28.3 mm²), and following drying, the electrode was treated in a vacuum dryer for 1 hour, thus obtaining a modified electrode in which the electrode catalyst had been supported on the glassy carbon electrode. The amount of the dispersion liquid applied was controlled so that the amount of the supported electrode catalyst in the modified electrode was 2.8 mg/cm². Using this modified electrode, similar operations to those described above in “(4) Evaluation of Oxygen Reduction Capability” were performed to determine the oxygen reduction current density for the electrode catalyst.

(6) Evaluation of Durability:

Each of the modified electrodes prepared in (5) above was immersed in an aqueous solution of sulfuric acid with a concentration of 0.1 mol/L, and using an RRDE speed controller (model name: SC-5, manufactured by Nikko Keisoku Co., Ltd.) and an electrochemical analyzer (model name: Model 701C, manufactured by BAS Inc.), a cycle treatment in which the potential was changed at a rate of 50 mV/second within a potential range from greater than 0.6 V to less than 1.0 V, under conditions of room temperature (approximately 25° C.), atmospheric pressure and an electrode rotation rate of 600 rpm, was performed 1,000 times. Subsequently, the oxygen reduction current density at 0.8 V following the 1,000 cycle treatments was measured, and the durability was evaluated using the ratio of this measured current density relative to the oxygen reduction current density at 0.8 V before the cycle treatments (namely, the oxygen reduction current density ratio). A larger oxygen reduction current density ratio indicates a smaller change in the oxygen reduction current density over the course of the cycle treatments, indicating a higher level of durability.

This evaluation method evaluates the durability in an acidic electrolyte, but because degradation of the electrode generally occurs more rapidly in an acidic electrolyte than in an alkaline electrolyte, the durability in an alkaline electrolyte was not evaluated, and the evaluation of the durability in an acidic electrolyte was used to judge the durability in alkaline electrolytes and acidic electrolytes.

(7) Work Function:

The work function was calculated from the energy value during current detection, which was obtained by performing a measurement at a light quantity of 500 nW and a measurement energy of 4.2 eV to 6.2 eV using a photoelectron analyzer AC-2 manufactured by Riken Keiki Co., Ltd.

(8) TEM, EF-TEM Observation:

Using a transmission electron microscope JEM2200FS manufactured by JEOL Ltd., observation was performed under vacuum conditions at an accelerating voltage of 200 kV. Confirmation that the Pt was supported in a metallic state was made by measuring the lattice spacing.

(9) XPS Analysis:

The state of the chemical bonding between the Pt supported by photodeposition and N was determined using an X-ray photoelectron spectrometer (Quantera SXM manufactured by Ulvac-Phi Inc.), and chemical bonds between Pt and N were deemed to exist when a measurement was performed using Al Kα rays (1486.6 eV) as the X-rays, and the count at 395 eV was 300 or greater.

### Example 1

(Reaction Apparatus used in Preparation of Carrier)

First, in example 1, the reaction apparatus used in preparing the carriers is described.

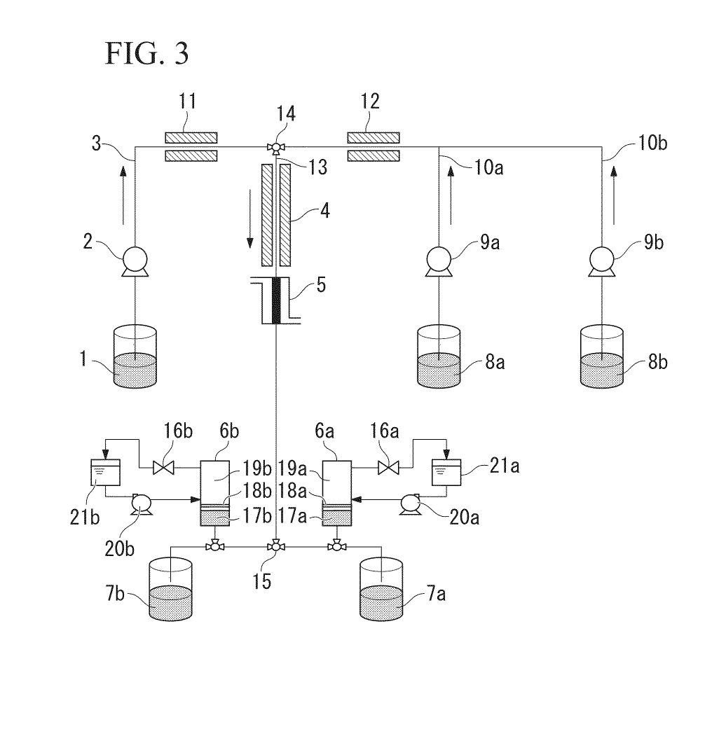

FIG. 3 is a diagram illustrating a continuous flow reaction apparatus used in example 1 for performing a continuous hydrothermal reaction.

Water tanks 1 and 8b are tanks for supplying water. A mixed slurry tank 8a is a tank for supplying a mixed slurry. The mixed slurry used is described below. Liquids are supplied from these tanks using liquid feed pumps 2, 9a and 9b. By operating the liquid feed pump 9a, a liquid is fed from the mixed slurry tank 8a, through a line 10a, into a heating unit 12. By operating the liquid feed pump 9b, a liquid is fed from the water tank 8b, through a line 10b, into the heating unit 12. By operating the liquid feed pump 2, a liquid is fed from the water tank 1, through a line 3, into a heating unit 11. These fed liquids are mixed in a mixing unit 14, and then pass through a line 13 and undergo a hydrothermal reaction, mainly in a reaction unit 4. Following the hydrothermal reaction, the produced slurry is cooled in a cooling unit 5, and is then fed along a flow direction that is switched by a directional control valve 15. The slurry is collected temporarily in a collection cylinder 6a or a collection cylinder 6b depending on the switching direction determined by the directional control valve 15, and is then finally collected in a collection tank 7a or a collection tank 7b.

In FIG. 3, by operating the liquid feed pumps 2, 9a and 9b, and opening and closing back pressure valves 16a and 16b, the pressure can be adjusted inside the lines between these liquid feed pumps 2, 9a and 9b and the back pressure valves 16a and 16b.

The collection cylinder 6a comprises a collection chamber 17a in which the product is collected, a movable partition 18a, and a pressure regulating chamber 19a which is adjacent to the collection chamber 17a with the partition 18a sandwiched therebetween. In the collection cylinder 6a, a pump 20a connected to the pressure regulating chamber 19a can be used to feed a fluid such as water from a storage tank 21a in which the fluid is stored into the pressure regulating chamber 19a, thereby pushing the movable partition 18a toward the collection chamber 17a and pressurizing the collection chamber 17a. Further, in a similar manner, the collection cylinder 6b comprises a collection chamber 17b, a partition 18b and a pressure regulating chamber 19b, and a pump 20b and a storage tank 21b can be used to pressurize the collection chamber 17b. As a result of the functions of these collection cylinders 6a and 6b, by adjusting the pressure inside the collection cylinders 6a and 6b, the pressure can be adjusted inside the lines from the feed pumps 2, 9a and 9b through to the back pressure valves 16a and 16b.

Furthermore, by adjusting the temperature of the heating units 11 and 12 and the reaction unit 4, supercritical state water or subcritical state water can be obtained.

In this type of apparatus, the liquid feed pumps 2, 9a and 9b are first activated, and the back pressure valves 16a and 16b are used to appropriately adjust the pressure inside the lines from the liquid feed pumps 2, 9a and 9b through to the back pressure valves 16a and 16b. Moreover, by appropriately adjusting the temperature of the heating units 11 and 12 and the reaction unit 4, the water inside the reaction unit 4 can be adjusted to a supercritical state or a subcritical state. When the mixed slurry is supplied from the mixed slurry tank 8a, the raw material in the mixed slurry undergoes a hydrothermal reaction inside the lines downstream from the mixing unit 14, and mainly in the reaction unit 4, thereby producing a hydrothermal reaction product. The produced slurry is first collected in the collection cylinders 6a and 6b, and is then transferred from the collection cylinders 6a and 6b to the collection tanks 7a and 7b, and collected in the collection tanks 7a and 7b.

### [Preparation of Carrier]

The chamber of a batch-type ready mill (model number: RMB-08, manufactured by Aimex Co., Ltd.) was charged with 60 g of a commercially available zirconium hydroxide (product name: R-type zirconium hydroxide, manufactured by Daiichi Kigenso Kagaku Kogyo Co., Ltd.), 80 g of D-glucose (manufactured by Wako Pure Chemical Industries, Ltd.), 160 g of an ammonia water (pH: 10.5), 2 g of ketchen black (product name: EC-300J, manufactured by Lion Corporation) and 0.2 g of a polyvinylpyrrolidone (manufactured by Wako Pure Chemical Industries, Ltd.), together with 1,000 g of 00.05 mm zirconia beads (manufactured by Tosoh Corporation), and the resulting mixture was dispersed for 120 minutes at a peripheral speed of 2,000 rpm. When the thus obtained mixed solution was analyzed using a particle size distribution analyzer (model name: Mastersizer 2000, manufactured by Malvern Instruments Ltd.) (refractive index: 2.17), the central particle size was 0.12 μm.

To 50 g of the obtained mixed solution was added and mixed 1,450 g of an ammonia water with a pH of 10.5, thus obtaining a mixed slurry. This mixed slurry was placed in the mixed slurry tank 8a of the continuous flow reaction apparatus illustrated in FIG. 3. The water tanks 1 and 8b were charged with water, and the liquid feed pumps 2 and 9b were activated to start supply of these waters. The flow rate in the liquid fee pump 2 was adjusted to 16.7 mL/minute, and the flow rate in the liquid feed pump 9bwas adjusted to 6.67 mL/minute. Using the back pressure valves 16a and 16b, the pressure inside the lines was adjusted to 30 MPa. The temperature of the heating unit 11 was adjusted to 400° C., the temperature of the heating unit 12 to 250° C., and the temperature of the reaction unit 4 to 350° C. When the liquid temperature inside the mixing unit 14 was measured under steady state conditions, the temperature was 380° C., confirming that the water was in a supercritical state.

Subsequently, the liquid feed pump 9b was halted, and by activating the liquid feed pump 9a, the mixed slurry was supplied from the mixed slurry tank 8a and subjected to a hydrothermal reaction, and a product slurry was collected in the collection cylinders 6a and 6b and the collection tanks 7a and 7b. The collected product slurry was subjected to a solid-liquid separation by filtering, and was then dried under vacuum at room temperature for approximately 1 day, yielding a mixed precursor.

The mixed precursor was placed in a crucible made of carbon, the crucible was placed in a box-type electric furnace (model number: NP-15S, manufactured by Nems Co., Ltd.) under atmospheric pressure, and following evacuation prior to increasing the temperature, the temperature was raised from room temperature (approximately 25° C.) to 800° C. at a rate of temperature increase of 300° C/hour, while nitrogen gas was circulated through the furnace at a flow rate of 1.0 L/minute, and once the temperature had been held at 800° C. for 1 hour, the temperature was cooled to room temperature (approximately 24° C.) at a rate of 300° C/hour to obtain a particulate carrier.

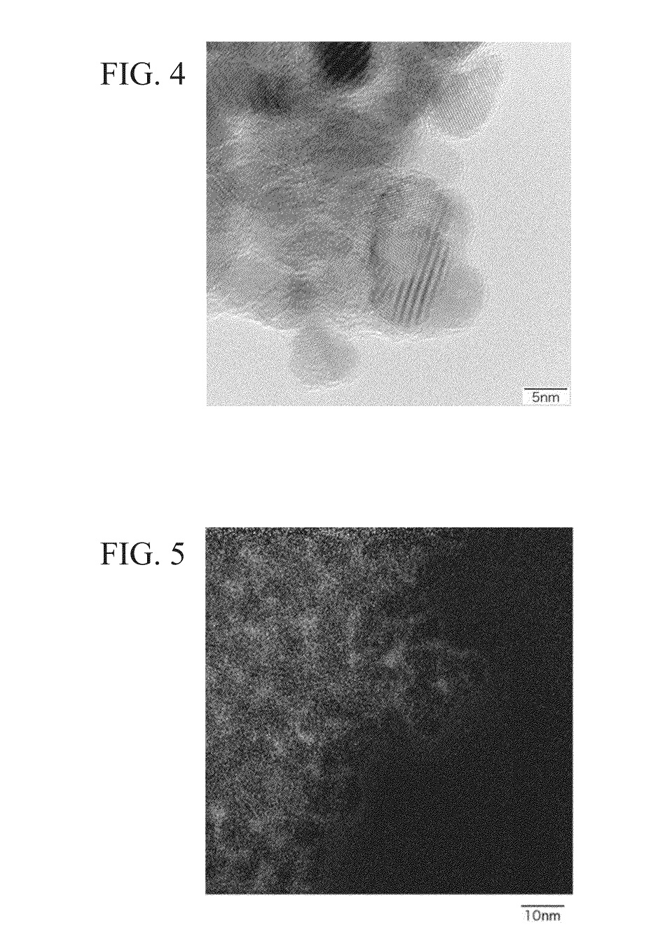

A TEM (transmission electron microscope) photograph of the obtained carrier is illustrated in FIG. 4, and an EF-TEM (energy-filtered transmission electron microscope) photograph of particles of the same compound is illustrated in FIG. 5. In the EF-TEM photograph illustrated in FIG. 5, the white portions indicate carbon. Confirmation using the photographs illustrated in FIG. 4 and FIG. 5 revealed that the obtained carrier was composed of carbon-coated particles of zirconium oxide with a primary particle size of approximately 10 nm. Further, it was also confirmed that the carbon which coated the surfaces of the particles also contained nitrogen.

Moreover, the BET specific surface area of the obtained carrier was 170 m²/g, the crystal form was tetragonal, and the carbon content was 28.1% by mass. Further, the oxygen reduction current density of the obtained carrier at 0.8 V was −0.384 mA/cm², and the fact that this value was not more −0.001 mA/cm² confirmed that the carrier had oxygen reduction capability. Further, the work function was 4.9 eV.

[Preparation of Electrode Catalyst containing Metal Deposited by Photodeposition]

A mixed solution was prepared by mixing 0.25 g of the obtained carrier, 24.93 g of water and 19.69 g of ethanol as solvents, 1.5 g of a solution (solid fraction concentration: 5% by mass) of Nafion (a registered trademark of E. I. du Pont de Nemours and Company) as a dispersant, and sufficient hexachloroplatinic acid (manufactured by Wako Pure Chemical Industries, Ltd.) as a precious metal compound to provide the equivalent of 5 parts by mass of Pt metal per 100 parts by mass of the carrier. The mixed solution was placed in a photochemical reaction test apparatus (light source cooling tube: quartz, manufactured by Ushio Inc.), and using a pen-shaped low-pressure mercury lamp (model: L937, manufactured by Hamamatsu Photonics K.K.) as a light source, the mixed solution was irradiated for 90 minutes under constant nitrogen bubbling, thus forming a dispersion liquid for an electrode catalyst.

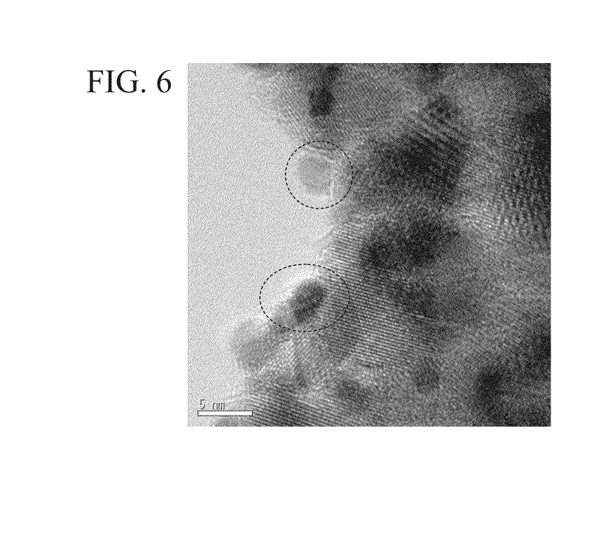

A TEM photograph of the obtained electrode catalyst is illustrated in FIG. 6. In the TEM photograph illustrated in FIG. 6, the regions encircled with dashed lines indicate primary particles of the supported platinum particles. Analysis of the TEM photograph illustrated in FIG. 5 confirmed that Pt particles with a primary particle size of 2 to 5 nm had been supported on the surface of the particulate carrier. The results of XPS analysis of the electrode catalyst revealed a count of 500 at 395 eV, and it was therefore evaluated that chemical bonds existed between the supported Pt and N incorporated within the carrier.

The current density value in an oxygen reduction current density evaluation of the obtained electrode catalyst was −2.80 mA/cm². Further, the results of a durability evaluation revealed an oxygen reduction current density ratio, of the value after cycling relative to the value before cycling, of 1.08.

### Comparative Example 1

A durability evaluation was performed for a commercially available platinum-supported carbon catalyst (manufactured by E-TEK Inc., Pt content: 20% by mass, carbon content: 80% by mass, a catalyst prepared by supporting platinum on carbon using a technique other than electrodeposition). The carbon black (product name: Vulcan XC-72, manufactured by Cabot Corporation) used in the above platinum-supported carbon catalyst exhibited an oxygen reduction current density of 0.00 mA/cm² at 0.8 V, and because this value is greater than −0.001 mA/cm², it can be evaluated as having no oxygen reduction capability.

The results of the evaluation revealed a value for the current density in the oxygen reduction current density evaluation for the electrode catalyst of −2.76 mA/cm², and an oxygen reduction current density ratio, of the value after cycling relative to the value before cycling, of 0.76. Further, the results of XPS analysis revealed a count of 200 at 395 eV, and therefore it could not be evaluated that chemical bonds existed between Pt and N.

### Comparative Example 2

A mixed solution was prepared by mixing 0.25 g of a powder of a commercially available tungsten oxide (manufactured by Nippon Inorganic Colour & Chemical Co.,

Ltd.), 24.93 g of water and 19.69 g of ethanol as solvents, 1.5 g of a solution (solid fraction concentration: 5% by mass) of Nafion (a registered trademark of E. I. du Pont de Nemours and Company) as a dispersant, and sufficient hexachloroplatinic acid (manufactured by Wako Pure Chemical Industries, Ltd.) as a precious metal compound to provide the equivalent of 5 parts by mass of Pt metal per 100 parts by mass of the carrier, and this mixed solution was placed in a photochemical reaction test apparatus (light source cooling tube: quartz, manufactured by Ushio Inc.), and using a pen-shaped low-pressure mercury lamp (model: L937, manufactured by Hamamatsu Photonics K.K.) as a light source, the mixed solution was irradiated for 90 minutes under constant nitrogen bubbling, thus forming a dispersion liquid for an electrode catalyst.

The current density value in an oxygen reduction current density evaluation of the obtained electrode catalyst was −2.24 mA/cm². Further, the results of a durability evaluation revealed an oxygen reduction current density ratio, of the value after cycling relative to the value before cycling, of 0.15.

The above results confirmed that the electrode catalyst manufactured using the method of manufacturing a dispersion liquid for an electrode catalyst according to the present invention was resistant to performance degradation in an acidic electrolyte or an alkaline electrolyte, even if a potential cycle including a high potential was performed.

### INDUSTRIAL APPLICABILITY

The present invention is able to provide a method of manufacturing a dispersion liquid, a dispersion liquid for an electrode catalyst, a method of manufacturing an electrode catalyst, an electrode catalyst which is resistant to performance degradation in an acidic electrolyte or an alkaline electrolyte even if a potential cycle including a high potential is performed, an electrode structure comprising the electrode catalyst, a membrane electrode assembly comprising the electrode structure, and a fuel cell and an air cell comprising the membrane electrode assembly, and is therefore extremely useful industrially.

### DESCRIPTION OF THE REFERENCE SIGNS

1, 8b: Water tank
2, 9a, 9b: Liquid feed pump
3, 10a, 10b, 13: Line
11, 12: Heating unit
4: Reaction unit
5: Cooling unit
6a, 6b: Collection cylinder
7a, 7b: Collection tank
8a: Mixed slurry tank
14: Mixing unit
15: Directional control valve
16a, 16b: Back pressure valve
17a, 17b: Collection chamber
18a, 18b: Partition
19a, 19b: Pressure regulating chamber
20a, 20b: Pump
21a, 21b: Storage tank
70: Membrane electrode gas diffusion layer assembly
72: Polymer electrolyte membrane
80: Fuel cell
88a, 88b: Separator

1. A method of manufacturing a dispersion liquid for an electrode catalyst, the method comprising: a step of supporting a precious metal on a surface of a carrier by an electrodeposition process using a raw material mixed solution in which a particulate carrier is dispersed in a solvent and a compound including the precious metal element is dissolved in the solvent,
wherein the carrier has oxygen reduction capability and is free of precious metal elements.

2. The method of manufacturing a dispersion liquid for an electrode catalyst according to claim 1,
wherein the electrodeposition process is performed by photodeposition.

3. The method of manufacturing a dispersion liquid for an electrode catalyst according to claim 1,
wherein the precious metal element is at least one precious metal element selected from the group consisting of Pt, Pd, Au, Ir and Ru.

4. A dispersion liquid for an electrode catalyst obtained by the method of manufacturing a dispersion liquid for an electrode catalyst according to claim 1.

5. A method of manufacturing an electrode catalyst, the method comprising:
removing the solvent from the dispersion liquid according to claim 4 to obtain an electrode catalyst.

6. An electrode catalyst obtained by the method of manufacturing an electrode catalyst according to claim 5.

7. An electrode catalyst comprising:
a particulate carrier having oxygen reduction capability and being free of precious metal elements; and
precious metal particles which are supported on a surface of the carrier;
wherein the carrier has a nitrogen atom at least on a surface thereof, and the nitrogen atom is chemically bonded to a precious metal element which forms the precious metal particles.

8. The electrode catalyst according to claim 7,
wherein the precious metal element which forms the precious metal particles is Pt.

9. An electrode structure comprising the electrode catalyst according to claim 6.

10. A membrane electrode assembly comprising the electrode structure according to claim 9.

11. A fuel cell comprising the membrane electrode assembly according to claim 10.

12. An air cell comprising the membrane electrode assembly according to claim 10.
